(19) United States
(12) Patent Application Publication
(10) Pub. No.: US 2023/0283975 A1
(43) Pub. Date: Sep. 7, 2023

(54) HEARING AID CALIBRATION DEVICE FOR SEMANTIC EVALUATION AND METHOD THEREOF

(71) Applicant: AWNT LIMITED, New Taipei City (TW)

(72) Inventor: YI-CHANG LIU, New Taipei City (TW)

(21) Appl. No.: 18/115,398

(22) Filed: Feb. 28, 2023

(30) Foreign Application Priority Data
Mar. 3, 2022 (TW) 111107662

(51) Int. Cl. H04R 25/00

(52) U.S. Cl. CPC H04R 25/70; H04R 25/30; H04R 2225/39

(57) ABSTRACT

The present disclosure relates to a hearing aid calibration device for semantic evaluation that utilizes a sound receiving module to receive a sound signal in an external environment, and a processing module receives the sound signal to compare the sound signal with a plurality of environmental data in an environmental database by executing a detection program, and when the processing module determines that the sound signal does not match any of the environmental data, the processing module executes a semantic evaluation program to generate a processed environmental data. Therefore, the device is able to dynamically adjust the output of the hearing aid according to different environmental noise conditions, which effectively provides hearing aid for the user in different environments.

### CROSS-REFERENCE TO RELATED APPLICATION

This application claims the benefit of Taiwan Patent Application No. 111107662, filed on Mar. 3, 2022, in the Taiwan Intellectual Property Office, the disclosure of which is incorporated herein in its entirety by reference.

### BACKGROUND

### 1. Field of the Invention

The present disclosure generally relates to the technical field of hearing aids, in particular to a hearing aid calibration device for semantic evaluation and method thereof that can adjust the hearing aid functions in different environments.

### 2. Description of the Related Art

In the process of human aging, the functions of various organs will gradually degenerate. Therefore, in order to improve the problem that people cannot clearly hear external sounds due to hearing degeneration, a hearing aid device is used to be attached to the human ears, and through processes such as noise removal or amplification, the external sound is output to the ear, so that people can clearly hear the external sound.

However, although hearing aids can help people with hearing disabilities improve their hearing impairment and thus improve their ability to communicate with others, the hearing aids may not be able to effectively provide the user with hearing aid functions due to excessive environmental noise in different environments.

As such, there is an urgent need for a hearing aid device that can be dynamically adjusted according to the state of different environmental noises, so that users can effectively achieve the effect of hearing aid in different environments, and to improve the existing problems of the prior art.

### SUMMARY

Therefore, it is an objective of the present disclosure to provide a hearing aid calibration device for semantic evaluation, which mainly utilizes a sound receiving module to receive a sound signal from the external environment, and then a processing module receives the sound signal and executes a detection program to compare the sound signal with a plurality of environmental data in an environmental database, when the processing module determines that the sound signal does not match any of the environmental data, the processing module executes a semantic evaluation program to generate a processed environmental data. As such, the function of dynamically adjusting the output of hearing aids according to different environmental noise conditions enables users to effectively achieve the effect of hearing aids in different environments.

To achieve the foregoing objective, the present disclosure provides a hearing aid calibration device for semantic evaluation including a sound receiving module which receives a sound signal from an external environment; and a processing module connected to the sound receiving module to receive the sound signal, the processing module executes a detection program to compare the sound signal with a plurality of environmental data in an environmental database, when the processing module determines that the sound signal does not match any of the environmental data, the processing module executes a semantic evaluation program to generate a processed environmental data.

In an example embodiment, when the processing module executes the detection program, the processing module determines an environmental noise in the sound signal, and compares the environmental noise with the plurality of environmental data in the environmental database.

In another example embodiment, the processing module identifies an environmental sound feature point of the environmental noise according to a plurality of sound feature point data, and compares the environmental sound feature point with a sound feature point of each of the environmental data.

In another example embodiment, the hearing aid calibration device for semantic evaluation further includes an output module connected to the processing module, when the processing module executes the semantic evaluation program, the processing module generates a test signal to be output to the output module, and outputs the test signal by the output module; wherein when the output module outputs the test signal, the sound receiving module receives a feedback signal corresponding to the test signal, and the sound receiving module outputs the feedback signal to the processing module.

In another example embodiment, when the processing module receives the feedback signal, the processing module determines a clarity value of the feedback signal based on a clarity threshold, and when the processing module determines that the clarity value is higher than the clarity threshold, the processing module generates the processed environmental data according to the sound signal.

In another example embodiment, when the processing module determines that the clarity value is lower than the clarity threshold, the processing module executes a calibration program to separate a plurality of sound sources in the test signal, and identifies a sound feature point in the sound sources according to a plurality of sound feature point data, the processing module utilizes a deep learning algorithm to extract a sound feature point audio of the sound source corresponding to a test sound feature point among the sound feature points, and amplifies the sound feature point audio of the sound source corresponding to the test sound feature point to generate a test sound source, and reduce the sound feature point audio in other sound sources that do not correspond to the test sound feature point to generate at least one adjustment sound source, wherein the processing module executes a synthesis program on the test sound source and the adjustment sound source, so that the test sound source and the adjustment sound source are combined to generate an adjustment test signal.

In another example embodiment, the processing module outputs the adjustment test signal to the output module, and the output module outputs the adjustment test signal, the sound receiving module receives an adjustment feedback signal corresponding to the adjustment test signal, and the sound receiving module outputs the adjustment feedback signal to the processing module.

In another example embodiment, when the processing module receives the adjustment feedback signal, the processing module determines a clarity value of the adjustment feedback signal based on the clarity threshold, and when the processing module determines that the clarity value of the adjustment feedback signal is higher than the clarity threshold, the processing module generates the processed environmental data according to an adjustment environmental noise in the adjustment test signal, and when the processing module determines that the clear value of the adjustment feedback signal is lower than the clarity threshold, the processing module executes the calibration program on the adjustment feedback signal.

In another example embodiment, when the processing module generates the processed environmental data according to the adjustment environmental noise in the adjustment test signal, the processing module separates the adjustment environmental noise in the adjustment test signal and a vocal sound source according to a vocal sound feature point data, so that the processing module generates the processed environmental data according to the adjustment environmental noise.

Another objective of the present disclosure is to provide a hearing aid calibration method for semantic evaluation, mainly by receiving a sound signal from an external environment by a sound receiving module, receiving the sound signal by a processing module, and the processing module executes a detection program to compare the sound signal with a plurality of environmental data in an environmental database, and executing a semantic evaluation program by the processing module to generate a processed environmental data when the processing module determines that the sound signal does not match any of the environmental data. As such, the function of dynamically adjusting the output of hearing aids according to different environmental noise conditions enables users to effectively achieve the effect of hearing aids in different environments.

To achieve the foregoing objective, the present disclosure further provides a bone conduction and air conduction hearing aid switching method for the aforementioned hearing aid calibration device for semantic evaluation, the method comprises: receiving a sound signal from an external environment with a sound receiving module; receiving the sound signal input by the sound receiving module through a bone conduction hearing aid module, and executing a bone conduction processing program based on the sound signal; receiving the sound signal input by the sound receiving module through an air conduction hearing aid module, and executing an air conduction processing program based on the sound signal; and when a switching module determines that a switching condition is met, the switching module executes a detection program to generate a switching data, and activates the bone conduction hearing aid module or the air conduction hearing aid module according to the switching data, so that the bone conduction hearing aid module or the air conduction hearing aid module receives the sound signal input by the sound receiving module.

The detailed structure, operating principle and effects of the inventive subject matter will now be described in more details hereinafter with reference to the accompanying drawings that show various embodiments of the invention as follows.

### BRIEF DESCRIPTION OF THE DRAWINGS

FIG. 1 is a schematic diagram showing a configuration between the modules according to an example embodiment of the inventive subject matter.

FIG. 2 is a schematic diagram showing the signal transmission system between the modules of an example embodiment.

FIG. 3 is a flow chart showing the steps of the detection program according to an example embodiment.

FIG. 4 is a flow chart showing the steps of the semantic evaluation program according to an example embodiment.

FIG. 5 is a flow chart showing the steps of an exemplary hearing aid calibration method.

FIG. 6 is a flow chart showing the steps of another embodiment of an hearing aid calibration method.

### DETAILED DESCRIPTION

The advantages, features and technical methods achieved by the present disclosure will be described in more detail with reference to exemplary embodiments and accompanying drawings for ease of understanding, and the inventive subject matter can be implemented in different forms, so it should not be construed that the present disclosure is limited to the embodiments set forth herein. Rather, the embodiments provided will make the scope of this disclosure more thorough and complete to convey the inventive subject matter to those of ordinary skill in the art, and the present invention will only be defined by the appended claims.

In addition, the terms “comprise” and/or “include” refer to the presence of stated features, regions, integers, steps, operations, elements and/or parts, but do not exclude the addition of one or more other stated features, regions, integers, steps, operations, elements and/or parts and/or combinations thereof.

For the convenience of understanding the content of the present disclosure, and the beneficial effects thereof, the specific embodiments presented in conjunction with the drawings are described in detail as follows:

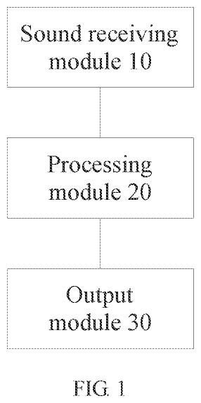

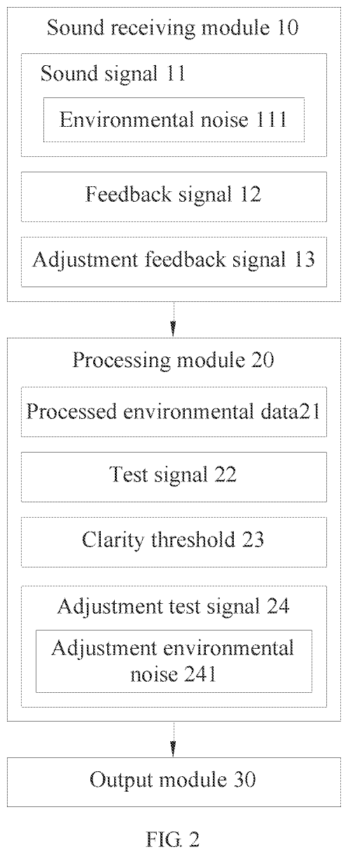

With reference to FIG. 1 to FIG. 4, showing a schematic diagram showing the configuration between the modules; a schematic diagram showing the signal transmission system between the modules; a flow chart showing the steps of the detection program; and a flow chart showing the steps of the semantic evaluation program, according to an example embodiment. As shown in FIG. 1 to FIG. 4, the hearing aid calibration device for semantic evaluation includes a sound receiving module 10, a processing module 20, and an output module 30. The sound receiving module 10 may be a microphone or other devices that can receive a sound signal 11 or other related signals from the external environment, wherein the sound signal 11 may be signals generated by wind sound, water sound, echo, mechanical knocking sound, keyboard tapping sound or other related environmental sounds. The above sounds may be any combination of two or more sounds to represent the environment in which the user is located. For example, when the sound signal 11 includes the sound of wind and water, it may indicate that the user is in a beach environment, or when the sound signal 11 includes the sound of mechanical knocking sound, it may indicate that the user is in a factory.

The processing module 20 may be a central processing unit or other devices capable of data processing. When the sound receiving module 10 receives the sound signal 11 from the user's current external environment, the processing module 20 can then receive the sound signal 11 from the sound receiving module 10, and executes a detection program to compare the sound signal 11 with a plurality of environmental data in an environmental database. When the processing module 20 determines that the sound signal 11 does not match the environmental data, the processing module 20 executes a semantic evaluation program to generate a processed environmental data 21. Each of the environmental data herein represents the processing programs corresponding to the sound signal 11 received in different environments.

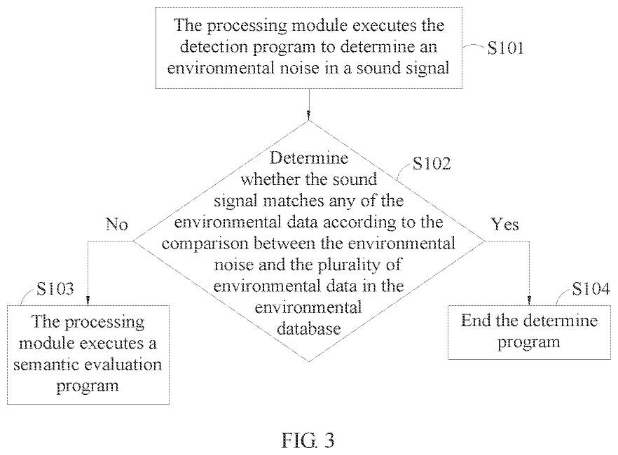

With reference to FIG. 3, when the processing module 20 executes the detection program, it mainly determines whether the plurality of environmental data stored in the environmental database matches the sound signal 11. If the results showed no match, it represents that the environmental database has not yet stored the processing program related to the environment corresponding to the sound signal 11, so the processing module 20 will execute the semantic evaluation program to generate the corresponding processed environmental data 21 (representing the environmental data after completing the semantic evaluation program). If the results showed a match, it represents that the environmental database has already stored relevant environmental data of the environment corresponding to the sound signal 11, so the processing module 20 does not need to perform the semantic evaluation program for the environment corresponding to the sound signal 11.

As such, when the processing module 20 executes the detection program, it may include:

S101: The processing module executes the detection program to determine an environmental noise in a sound signal.

In order to determine whether the corresponding environment in the sound signal 11 matches the plurality of environmental data in the environmental database, it may first extract an environmental noise 111 in the sound signal 11, and the processing module 20 may further identify an environmental sound feature point of the environmental noise 111 according to a plurality of sound feature point data (for example, data which records different environmental sound feature points).

S102: Determine whether the sound signal matches any of the environmental data according to the comparison between the environmental noise and the plurality of environmental data in the environmental database.

When the processing module 20 completes the determination of the environmental noise 111, it can be compared with a sound feature point of each of the environmental data in the environmental database (each of the environmental data may record environmental noises in different environments, for example, each of the environmental data may correspond to the sound feature points of the environmental noise in an environment), so as to determine whether the environmental noise 111 matches any of the environmental data.

S103: When the processing module determines that the sound signal does not match any of the environmental data, the processing module executes a semantic evaluation program.

When the processing module 20 determines that the sound signal 11 does not match any of the environmental data, the processing module 20 will need to execute and complete the semantic evaluation program for the environment corresponding to the sound signal 11, so as to perform an appropriate hearing aid calibration program for the environment corresponding to the sound signal 11.

S104: When the processing module determines that the sound signal matches any of the environmental data, the determine program will be terminated.

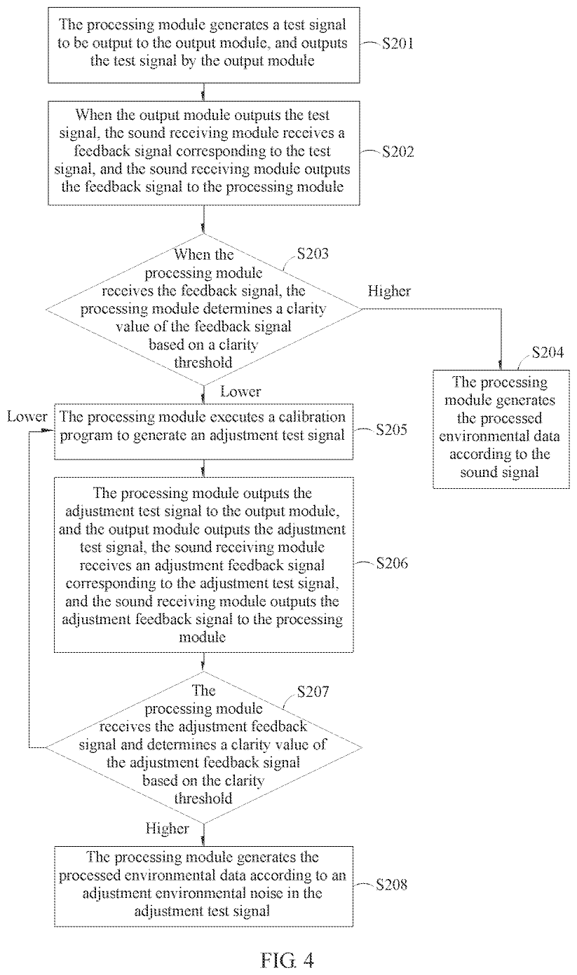

With reference to FIG. 4, when the processing module 20 completes the detection program, and determines that the sound signal 11 does not match any of the environmental data, and needs to execute and the semantic evaluation program for the environment corresponding to the sound signal 11, the processing module 20 mainly utilizes the semantic evaluation program to generate the processed environmental data 21, so as to record the corresponding hearing aid processing program in that environment according to the processing environment data 21.

As such, when the processing module 20 executes the semantic evaluation program, it may include:

S201: The processing module generates a test signal to be output to the output module, and outputs the test signal by the output module.

When the processing module 20 generates the test signal 22, the test signal 22 can be formed in the form of a word string, and the word string may be composed of a string of Chinese characters or a foreign language (such as “hearing test under different environment begins”), the test signal 22 is converted by the output module 30 and then output to the user's ears. Preferably, it is desirable to use a relatively unfamiliar language for the user to form the word string, so as to accurately test whether the user can clearly hear the output of the test signal 22. For example, when the user's mother tongue is Chinese, even if the user cannot clearly hear the word string of “hearing test under different environment begins” in Chinese, the user can still recognize and guess the content output by the test signal 22 according to the users familiarity with the language when the user hears “different envir-” and “hearing tes-” in Chinese vaguely, but if the user is relatively unfamiliar with the English language, even if the user is able to recognize “hearing” and “under different environment”, the user may not be able to guess that the content output by the test signal 22 was “hearing test under different environment begins”, and therefore may be more accurate when testing whether the user can hear the content output by the test signal 22 clearly.

S202: When the output module outputs the test signal, the sound receiving module receives a feedback signal corresponding to the test signal, and the sound receiving module outputs the feedback signal to the processing module.

When the test signal 22 is output, the user can listen to the converted output word string (for example, the aforementioned “hearing test under different environment begins”) of the test signal 22 through the output module 30, and speak the content they heard so the sound receiving module 10 may receive the word string the user said and convert it into the feedback signal 12 corresponding to the test signal 22 (i.e. the feedback signal 12 corresponding to the word string of the test signal 22), and output the feedback signal 12 to the processing module 20.

S203: When the processing module receives the feedback signal, the processing module determines a clarity value of the feedback signal based on a clarity threshold; when the processing module determines that the clarity value is higher than the clarity threshold, execute step S204, and when the processing module determines that the clarity value is lower than the clarity threshold, execute step S205.

Since the feedback signal 12 records the content spoken by the user based on the content of the word string they heard, when the feedback signal 12 is output to the processing module 20, the processing module 20 will evaluate the clear value of the word string content in the feedback signal 12 according to the set clarity threshold 23 to determine whether the user can effectively hear the content in that environment. For example, when the clarity threshold 23 is set at 80%, it means that in the word string of the test signal 22 above, there may be one words being pronounced similar (to the correct word) or one word missing, while the other words are pronounced correctly, for example, in the word string of “hearing test under different environment begins”, the feedback signal 12 may be “hearing test undo different environment begins” where the word “undo” is pronounced different than the word “under” of the test signal 22, but sounded similar, or the feedback signal 12 may be “hearing test under different begins” where the word “environment” is missing, but the other words are pronounced correctly, therefore the clear value of the above feedback signal 12 may be determined to be 83% (i.e. higher than the clarity threshold), but when the feedback signal 12 is “hearing tent odor different environment begins”, or “ring different environment beg”, the clear value would be determined to be lower than the clarity threshold 23 of 80%.

S204: The processing module generates the processed environmental data according to the sound signal.

When the processing module 20 determines that the clarity value of the feedback signal 12 is higher than the clarity threshold 23 through the above determine process, it means that the processing module 20 determines that the hearing aid processing program can provide an appropriate hearing aid function (i.e. the user can clearly hear the sound input by the hearing aid in their current environment according to the signal processing program). Therefore, the sound signal 11 can be processed directly according to the processing program (such as the default hearing aid processing program), and generate the processed environmental data 21 (i.e. recording the environmental data corresponding to the sound signal 11) according to the sound signal 11. As such, when the user is in an environment corresponding to the processed environment data 21 and the processing module 20 receives the relevant sound signal, the device can perform relevant signal processing according to the hearing aid processing program recorded in the processed environmental data 21.

S205: The processing module executes a calibration program to generate an adjustment test signal.

When the clarity value is lower than the clarity threshold 23, it means that the user cannot clearly hear the external sound in the environment, so the processing module 20 may execute the calibration program to effectively adjust such as the environmental noise or human voice input by the sound signal 11 and further generate the adjustment test signal 24. Wherein when the processing module 20 executes the calibration program, it may separate a plurality of sound sources (for example, wind and human voice (may be the vocal of the word string of the aforementioned test signal 22)) in the test signal 22, and identify a sound feature point in the sound sources according to a plurality of sound feature point data (i.e. using feature points to identify the sound of wind and human voice). The processing module 20 utilizes a deep learning algorithm to extract a sound feature point audio of the sound source corresponding to a test sound feature point among the sound feature points, and amplifies the sound feature point audio of the sound source corresponding to the test sound feature point to generate a test sound source (i.e. amplifies the parts of human voice (for example, electronic voice)), and reduce the sound feature point audio in other sound sources that do not correspond to the test sound feature point to generate at least one adjustment sound source (i.e. reduce the sounds of wind), wherein the processing module 20 executes a synthesis program on the test sound source and the adjustment sound source, so that the test sound source and the adjustment sound source are combined to generate the adjustment test signal 24.

S206: The processing module outputs the adjustment test signal to the output module, and the output module outputs the adjustment test signal, the sound receiving module receives an adjustment feedback signal corresponding to the adjustment test signal, and the sound receiving module outputs the adjustment feedback signal to the processing module.

After the adjustment test signal 24 is generated by the processing module 20 executing the calibration program, the processing module 20 will then output the adjustment test signal 24 to the output module 30, so as to be output through the output module 30 to the user for another test operation. When the user hears the content of the word string in the adjustment test signal 24 and correspondingly speaks the content of the word string they heard, the sound receiving module 10 may receive the word string the user said and convert it into the adjustment feedback signal 13 corresponding to the adjustment test signal 24. As such, it would be determined again whether the amplification and noise reduction program of the adjustment test signal 24 can effectively provide the hearing aid function for the user under their environmental conditions.

S207: The processing module receives the adjustment feedback signal and determines a clarity value of the adjustment feedback signal based on the clarity threshold; when the processing module determines that the clarity value of the adjustment feedback signal is higher than the clarity threshold, execute step S208, and when the processing module determines that the clarity value of the adjustment feedback signal is lower than the clarity threshold, execute step S205.

Here, the determining of the clarity value of the adjustment feedback signal 13 by the processing module 20 may follow the aforementioned step S204, so as to determine if the clarity value is higher or lower than the clarity threshold 23.

S208: The processing module generates the processed environmental data according to an adjustment environmental noise in the adjustment test signal.

When the processing module 20 generates the processed environmental data 21 according to the adjustment environmental noise 241 in the adjustment test signal 24, the processing module 20 may separate the adjustment environmental noise 241 recorded in the adjustment test signal 24 and the human voice generated in the adjustment test signal 24 according to a vocal sound feature point data, so that the processing module 20 may generate the processed environmental data 21 according to the adjustment environmental noise 241 in the adjustment test signal 24.

In this way, the hearing aid calibration device for semantic evaluation of the present invention may dynamically adjusting the output of hearing aids according to different environmental noise conditions enables users to effectively achieve the effect of hearing aids in different environments.

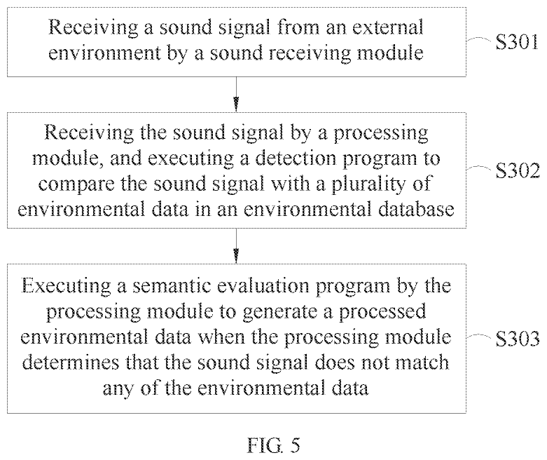

With reference to FIG. 5, illustrating the following steps to achieve the hearing aid calibration method for semantic evaluation of the hearing aid calibration device for semantic evaluation of the above, which includes:
S301: Receiving a sound signal from an external environment by a sound receiving module;
S302: Receiving the sound signal by a processing module, and executing a detection program to compare the sound signal with a plurality of environmental data in an environmental database; and
S303: Executing a semantic evaluation program by the processing module to generate a processed environmental data when the processing module determines that the sound signal does not match any of the environmental data.

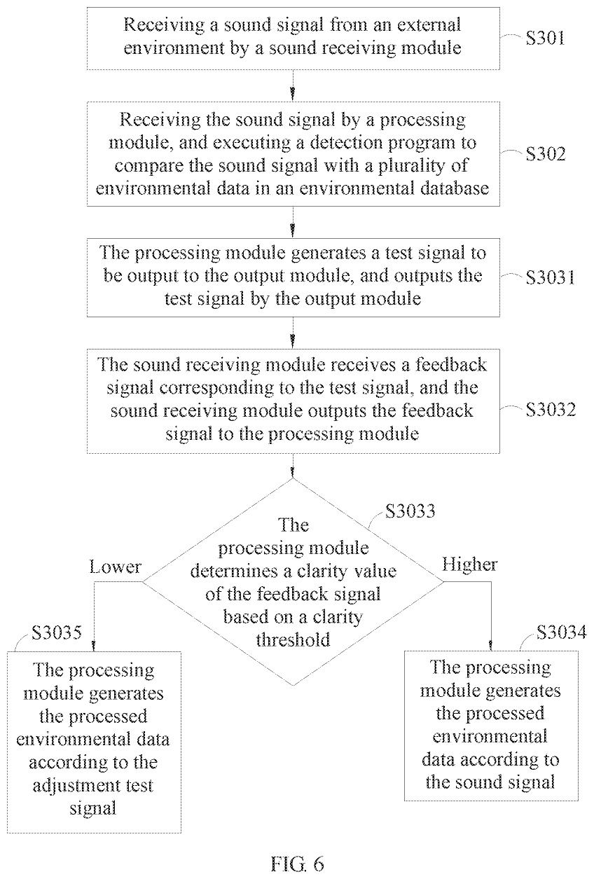

With reference to FIG. 6 showing the steps of another embodiment of an hearing aid calibration method for semantic evaluation of the hearing aid calibration device. The method includes:
S301: Receiving a sound signal from an external environment by a sound receiving module;
S302: Receiving the sound signal by a processing module, and executing a detection program to compare the sound signal with a plurality of environmental data in an environmental database;
S3031: The processing module generates a test signal to be output to the output module, and outputs the test signal by the output module;
S3032: The sound receiving module receives a feedback signal corresponding to the test signal, and the sound receiving module outputs the feedback signal to the processing module;
S3033: The processing module determines a clarity value of the feedback signal based on a clarity threshold;
S3034: When the processing module determines that the clarity value is higher than the clarity threshold, the processing module generates the processed environmental data according to the sound signal;
S3035: When the processing module determines that the clarity value is lower than the clarity threshold, the processing module executes a calibration program to generate an adjustment test signal, and when the clarity value of the adjustment test signal is higher than the clarity threshold, the processing module generates the processed environmental data according to the adjustment test signal.

While the means of specific embodiments in the present disclosure has been described, numerous modifications and variations could be made thereto by those skilled in the art without departing from the scope and spirit of the invention set forth in the claims.

What is claimed is:

1. A hearing aid calibration device for semantic evaluation, comprising:
a sound receiving module which receives a sound signal from an external environment; and
a processing module connected to the sound receiving module to receive the sound signal, the processing module executes a detection program to compare the sound signal with a plurality of environmental data in an environmental database, when the processing module determines that the sound signal does not match any of the environmental data, the processing module executes a semantic evaluation program to generate a processed environmental data.

2. The hearing aid calibration device for semantic evaluation of claim 1, wherein when the processing module executes the detection program, the processing module determines an environmental noise in the sound signal, and compares the environmental noise with the plurality of environmental data in the environmental database.

3. The hearing aid calibration device for semantic evaluation of claim 2, wherein the processing module identifies an environmental sound feature point of the environmental noise according to a plurality of sound feature point data, and compares the environmental sound feature point with a sound feature point of each of the environmental data.

4. The hearing aid calibration device for semantic evaluation of claim 1, further comprising:
an output module connected to the processing module, when the processing module executes the semantic evaluation program, the processing module generates a test signal to be output to the output module, and outputs the test signal by the output module;
wherein when the output module outputs the test signal, the sound receiving module receives a feedback signal corresponding to the test signal, and the sound receiving module outputs the feedback signal to the processing module.

5. The hearing aid calibration device for semantic evaluation of claim 4, wherein when the processing module receives the feedback signal, the processing module determines a clarity value of the feedback signal based on a clarity threshold, and when the processing module determines that the clarity value is higher than the clarity threshold, the processing module generates the processed environmental data according to the sound signal.

6. The hearing aid calibration device for semantic evaluation of claim 5, wherein when the processing module determines that the clarity value is lower than the clarity threshold, the processing module executes a calibration program to separate a plurality of sound sources in the test signal, and identifies a sound feature point in the sound sources according to a plurality of sound feature point data, the processing module utilizes a deep learning algorithm to extract a sound feature point audio of the sound source corresponding to a test sound feature point among the sound feature points, and amplifies the sound feature point audio of the sound source corresponding to the test sound feature point to generate a test sound source, and reduce the sound feature point audio in other sound sources that do not correspond to the test sound feature point to generate at least one adjustment sound source, wherein the processing module executes a synthesis program on the test sound source and the adjustment sound source, so that the test sound source and the adjustment sound source are combined to generate an adjustment test signal.

7. The hearing aid calibration device for semantic evaluation of claim 6, wherein the processing module outputs the adjustment test signal to the output module, and the output module outputs the adjustment test signal, the sound receiving module receives an adjustment feedback signal corresponding to the adjustment test signal, and the sound receiving module outputs the adjustment feedback signal to the processing module.

8. The hearing aid calibration device for semantic evaluation of claim 7, wherein when the processing module receives the adjustment feedback signal, the processing module determines a clarity value of the adjustment feedback signal based on the clarity threshold, and when the processing module determines that the clarity value of the adjustment feedback signal is higher than the clarity threshold, the processing module generates the processed environmental data according to an adjustment environmental noise in the adjustment test signal, and when the processing module determines that the clear value of the adjustment feedback signal is lower than the clarity threshold, the processing module executes the calibration program on the adjustment feedback signal.

9. The hearing aid calibration device for semantic evaluation of claim 7, wherein when the processing module generates the processed environmental data according to the adjustment environmental noise in the adjustment test signal, the processing module separates the adjustment environmental noise in the adjustment test signal and a vocal sound source according to a vocal sound feature point data, so that the processing module generates the processed environmental data according to the adjustment environmental noise.

10. A hearing aid calibration method for semantic evaluation of the hearing aid calibration device for semantic evaluation of claim 1, comprising:
receiving a sound signal from an external environment by a sound receiving module;
receiving the sound signal by a processing module, and executing a detection program to compare the sound signal with a plurality of environmental data in an environmental database; and
executing a semantic evaluation program by the processing module to generate a processed environmental data when the processing module determines that the sound signal does not match any of the environmental data.
